(19) United States
(12) Patent Application Publication
(10) Pub. No.: US 2003/0129287 A1
(43) Pub. Date: Jul. 10, 2003

(54) Systems, methods and apparatus for producing a frozen confection

(76) Inventors: Adriana T. Guzman, Cambridge, MA (US); Horacio Guzman, San Jose (CR); Miriam Sibaja, San Jose (CR); Julian E. Orbanes, Cambridge, MA (US)

Correspondence Address: Mintz, Levin, Cohn, Ferris,, Glovsky and Popeo, P.C., One Financial Center, Boston, MA, 02111, US

(21) Appl. No.: 10/310,327

(22) Filed: Dec. 4, 2002

Related U.S. Application Data
(60) Provisional application No. 60/336,674, filed on Dec. 5, 2001.

(51) Int. Cl. A23G 1/00

(52) U.S. Cl. 426/282

(57) ABSTRACT

Systems, methods and an apparatus for making a frozen confection comprising a malleable outer layer of a first edible substance suitable for forming a shape or configuration to contain a second edible substance are provided. In at least one embodiment of the invention, the outer layer of the first edible substance, e.g., ice cream, is sufficiently malleable such that the outer layer can be rolled and/or folded over the second edible substance, e.g. flavored filling, to form a frozen confection. The outer layer is sufficiently thin such that no air or minimal air is contained in the outer layer to help to prevent or to at least minimize/reduce the formation of ice crystals in the outer layer. Minimizing/reducing the formation of ice crystals helps to prevent or to at least minimize/reduce breaking and cracking of the outer layer during shaping, and helps to preserve a sufficient malleability of the outer layer. Alternatively, in another embodiment, the first edible substance is formed by an emulsification process to form an emulsion from which the outer layer is configured. In other embodiments, the outer layer can be formed into a shape or configuration using a mold and can be filled with the second edible substance. The outer layer can also be formed using a mold or other shaping devices to produce a solid frozen confection.

### CLAIM OF PRIORITY TO PRIOR APPLICATION

This application claims priority under 35 U.S.C. § 119(e) to U.S. provisional patent application Ser. No. 60/336,374, filed Dec. 5, 2001, which is incorporated herein by reference in its entirety.

### FIELD OF THE INVENTION

Embodiments of the invention generally relate to systems, methods and an apparatus for making frozen confections, such as those made from ice cream, frozen yogurt, and the like. More particularly, the invention relates to systems, methods and an apparatus for producing a frozen confection using a layer of a frozen edible substance that is formed to contain an inner edible filling.

### BACKGROUND OF THE INVENTION

Consumption of frozen confections, including ice cream, ice milk, frozen yogurt, frozen fruit, frozen non-dairy products, frozen candy, and other frozen items, in the United States and worldwide, increases every year. Consumers, moreover, always seem to be receptive to new ways of consuming their favorite frozen treats. No longer limited to consuming ice cream from a cone or a cup, consumers have embraced many different ways of eating frozen desserts, including products such as ice cream sandwiches, frozen fruit on a stick, chocolate coated ice cream bars, frozen confections capable of being squeezed or urged from non-edible containers, e.g., commonly known as “freeze pops”. In particular, consumers seem to have been especially receptive to frozen confections that are easy to carry and hold, especially for children.

Another increasing trend with consumer food items is customization. Many food products, such as tacos, burritos, sushi, sandwiches, and the like, are customized at the time of serving or preparing to a consumer's exact requirements. These food products can be prepared with the precise combination of fillings a consumer desires. This trend has caught on with some types of frozen confections, such as ice cream purchased from an ice cream store that can “mix in” a desired item, such as chocolate chips, cookie crumbs, and the like, into the ice cream, which is then consumed in the conventional manner, e.g., with a spoon, from a cone, or with a straw.

### SUMMARY OF THE INVENTION

The invention provides systems, methods and an apparatus for making frozen confections comprising an outer layer of a frozen edible substance, e.g., ice cream, formed around a second internal edible substance or filling. The invention provides systems, methods and an apparatus for providing a malleable outer layer comprised of a first edible substance suitable for cooling or freezing. The outer layer can have a thickness that is sufficiently thin to help to form the outer layer into a desired or required shape or configuration to contain at least a portion of the second edible substance. In addition, the outer layer according to the invention can be sufficiently thin to help to prevent the formation of ice crystals in the outer layer such that breaking or cracking of the outer layer is prevented or at least minimized/reduced. The temperatures, ingredients and dimensions of the outer layer are varied to help to preserve a substantial malleability of the outer layer.

In one embodiment, the second edible material is disposed in or on at least a portion of the outer layer and the outer layer is formed into a shape or configuration to contain at least a portion of the second edible material. In another embodiment of the invention, the outer layer is shaped to define a desired or required shape or configuration and is configured such that it can be later filled with the second edible substance. In yet another embodiment, the outer layer is molded and filled with the second edible substance. In a further embodiment, the outer layer is molded to form a substantially solid shape or configuration comprised at least in part of the first edible substance. In still a further embodiment, the outer layer and the second edible substance have different temperatures. In another embodiment, the outer layer and the second edible substance have substantially similar temperatures. Other embodiments are within the scope of the invention.

### BRIEF DESCRIPTION OF THE DRAWINGS

FIG. 1 is a process block diagram of a method for making a frozen confection according to one aspect of the invention.

FIG. 2A is perspective view of an outer layer formed of a first edible substance formed according to the method shown in FIG. 1.

FIG. 2B is a perspective view of the outer layer of FIG. 2A containing a second edible substance according to the method shown in FIG. 1.

FIG. 2C is a perspective view of the frozen confection made according to the method shown in FIG. 1.

FIGS. 3A-3C include perspective views of different shapes of the frozen confection made according to the method shown in FIG. 1.

FIG. 4 is a process block diagram of a method for making a frozen confection according to another aspect of the invention.

FIG. 5 is a perspective view of the frozen confection having an inner portion made according to the method shown in FIG. 4.

FIG. 6 is a process block diagram of a method for making a frozen confection according to still another aspect of the invention.

FIGS. 7A-7F include perspective views of the frozen confection made according to the method shown in FIG. 6.

FIG. 8 is a perspective view of one embodiment of the outer layer including a tubular or cylindrical shape.

FIG. 9 is a perspective illustration of a dispensing apparatus to dispense an edible substance.

### DETAILED DESCRIPTION OF PREFERRED EMBODIMENTS

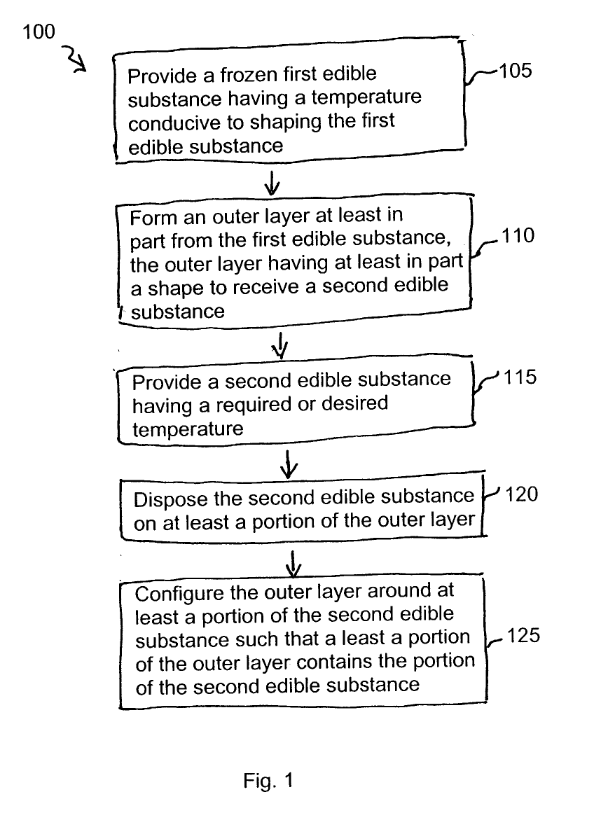

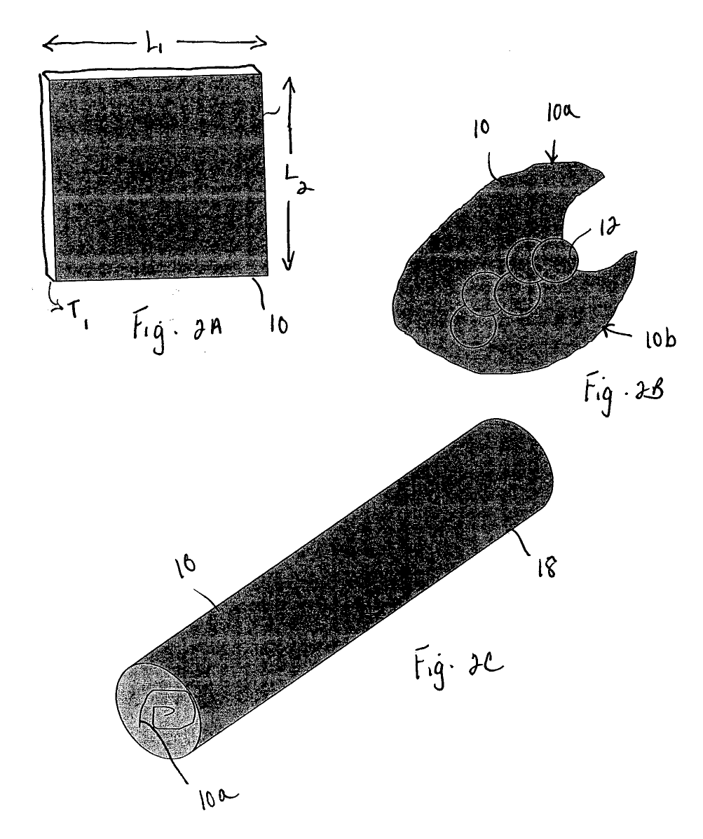

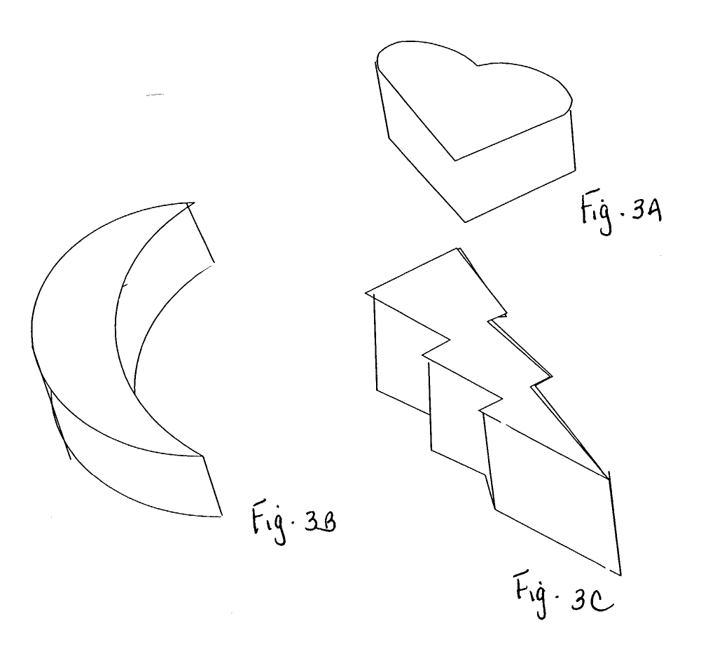

Referring to FIG. 1, with further reference to FIGS. 2A-2C, in one aspect, a method 100 for making a frozen confection 18 using a substantially malleable outer layer 10 comprised of a first edible substance to hold or contain a second edible substance 12 is provided. The method 100, however, is exemplary only and not limiting. The method 100 can be altered, e.g., by having stages added, removed or rearranged.

At stage 105, a first edible substance is provided suitable for forming a physical structure when subjected to low temperatures sufficient for cooling or freezing the first edible substance. The first edible substance can include any edible material suitable for freezing and for forming into a shape or configuration such that the resultant frozen confection 18 comprises a shape or configuration that is desirable for consumption. The first edible substance includes, but is not limited to, ice cream, e.g., homemade, gourmet shop or commercially-available ice cream, ice milk, frozen yogurt, frozen fruit, frozen dairy product, frozen non-dairy product, frozen non-dairy, milk-like product, any other frozen edible article, creme filling, cookies, candy, fruit, fruit roll-up type materials, pastry-like layers of edible material or any combination thereof The first edible substance can further include, but is not limited to, flavorings, e.g., natural or artificial, jellies, jams, vegetables, savory ingredients, e.g., herbs or spices, sundries, e.g., nuts, raisins, dried fruit or coconut, colors, e.g., provided by natural or artificial additives, other ingredients, e.g., sugar, non-sugar sweeteners, milk, eggs, butter, butter fat, pastry, dough, flour, corn starch, salt, preservatives, or any combination thereof

In one embodiment, the first edible substance can be provided frozen, e.g., at a temperature of ranging from about −196 ° C. to about −10 ° C., e.g., for ice cream. In another embodiment, the first edible substance can be provided at a cool temperature, e.g. from about −10° C. to about 0° C., e.g., for ice cream, or provided at a room or warmer temperature. In at least one embodiment, the first edible substance is provided at a temperature conducive to help to permit the first edible substance to be formed into a shape or configuration desired or required for a certain application.

At stage 110, the outer layer 10 is formed at least in part from the first edible substance. The outer layer 10 can be formed manually, e.g., by hand, using an implement, e.g., a spatula, rolling pin, or other tool, with or without a non-stick finish that is capable of rolling out, folding and/or shaping the first edible substance on a surface, e.g., a substantially flat surface, similar to rolling out, folding and/or shaping dough, and is capable of helping to shape and to adjust a configuration of the first edible substance into the outer layer 10 without sticking to and/or puncturing the outer layer 10 during its formation. In at least one embodiment, the first edible substance is cold or frozen to help to permit manual manipulation of the first edible substance into the desired or required shape of the outer layer 10. In another embodiment, the first edible substance has a temperature that is conducive to manipulating the first edible substance into the outer layer 10 and/to help to preserve a shape or configuration of the outer layer 10. Once formed, the outer layer 10 can be cooled or warmed to a second temperature that is suitable for helping the outer layer 10 to retain its shape and for storing the outer layer 10 for a period of time, e.g., cooled to a freezing temperature, or suitable for serving the outer layer 10 or forming, e.g., immediately, the outer layer 10 into a resultant frozen confection. In another embodiment, the first edible substance is suitable for manipulating its physical structure into a desired or required shape of the outer layer such that the physical structure of the first edible substance is different once formed into the outer layer 10.

The invention, however, is not limited to manually rolling, folding and/or shaping the first edible substance into the outer layer 10, but anticipates other methods of rolling out, folding and/or shaping the frozen edible substance, e.g., using a manually-operated rolling machine, an automatic rolling tool, an automatic rolling machine or any combination of such devices.

In one embodiment, as shown in FIGS. 3A-3C, the outer layer 10 can be shaped using a mold of a desired or required shape, e.g., a heart, half-moon or lightening bolt. In one embodiment, if the first edible substance is a cold or frozen substance, the first edible substance can be added to the mold by raising a temperature of the first edible substance to a first temperature by heating and/or melting the first edible substance to a room or warmer temperature such that the first edible substance has sufficient fluidity to pour into the mold.

A temperature of the first edible substance in the mold can then be lowered to a second temperature by cooling or freezing the first edible material such that the first edible material returns to a cold or frozen substance and retains the shape of the mold. For example, the mold can include a circular shape having a narrow depth such that the first edible substance can be formed into the outer layer 10 having a wafer-like configuration. As shown in FIGS. 3A-3C, the mold can include any type of shape or configuration.

In another embodiment, the first edible substance can be added to the mold at a first temperature, e.g., at room temperature, and the first edible substance and the mold can be brought to a second temperature, e.g., a temperature sufficiently cold to cool or freeze the edible substance such that the outer layer 10 formed from the first edible substance retains the shape of the mold when it is removed from the mold. In another embodiment, the edible food substance can be added to a mold in a chilled or frozen state, and “pressed” or formed into the mold. In a further embodiment, the outer layer 10 can be formed by pouring the first edible substance at room or warmer temperature into or onto a surface, or into or onto a pan, having a desired or required shape of the outer layer 10, e.g., similar to pouring and forming crepes. The outer layer 10, thereafter, is subjected to a temperature sufficiently cold to cool or freeze the first edible substance such that the outer layer 10 formed retains the desired or required shape of the surface or pan. In another embodiment of the invention, the outer layer 10 can be shaped into various pasta-like shapes or configurations, e.g., a macaroni shell or a ziti or manicotti tube, by manual manipulation, automated shaping or use of molds.

In one embodiment, the outer layer 10 can be shaped or formed at least in part from the first edible substance by wrapping the first edible substance in a non-stick wrapping material and shaping the first edible material into a desired or required shape. The non-stick wrapping material is suitable for use in temperatures sufficiently cold to cool or freeze the first edible substance. After wrapping and shaping the first edible substance in the non-stick material, the outer layer 10 is sufficiently cooled or frozen to retain its shape and/or to help to provide sufficient conformability such that the outer layer 10 can be further manipulated, e.g., shaped, configured and processed. The non-stick material can then peeled from the outer layer 10. A suitable non-stick material includes, but is not limited to, a flexible plastic wrap, a wax paper, other conformable wrapping material or any combination thereof. The type of non-stick material that is used is dependent on one or more temperatures at which the first edible substance is wrapped, shaped, conformed, chilled, frozen and/or manipulated while wrapped in the non-stick material. In another embodiment, the first edible substance can be disposed over and/or around an implement, e.g., a shaping or molding device, and wrapped with the non-stick material to permit the first edible substance to be shaped or formed manually and/or automatically over and/or around the implement such that the first edible substance encases the implement and the outer layer 10 thereby assumes at least a portion of a shape or configuration of the implement.

In another embodiment, one or more surfaces of the non-stick wrapping material can include a coating of a non-stick substance, e.g., butter, a flavorless oil or an oil spray, such as PAM®, applied before wrapping the first edible substance in the non-stick wrapping material to help to prevent or to at least minimize/reduce sticking of the first edible substance and/or to help to aid in achieving a quick retrieval or removal of the first edible substance from the wrapping material. In addition, the coating of the non-stick substance contacts one or more surfaces of the first edible substance and helps to preserve and/or to increase a degree of malleability of the first edible substance and the resultant outer layer 10 that is desirable or required in some applications and, in particular, facilitates the formation of the outer layer 10. Once wrapped in the coated non-stick wrapping material, the first edible substance can be formed into the outer layer 10 and the wrapping material thereafter peeled from the first edible material for further manipulation. Alternatively, the first edible substance can be wrapped in the coated non-stick wrapping material then chilled or frozen and thereafter the wrapping material can be peeled from or remain disposed on the frozen first edible substance for further manipulation to form the outer layer 10.

In another embodiment, the non-stick substance can be applied directly to the first edible substance during the formation of the outer layer 10 in order to help to preserve or to increase the malleability and/or the consistency of the first edible substance, which thereby helps to facilitate the formation of the outer layer 10.

In other embodiments, surfaces of the molds, the surface or the pan can include a coating of a non-stick substance applied before loading of the first edible substance to help to prevent or to at least minimize/reduce sticking of the first edible substance and/or to help to aid in achieving a quick retrieval or removal of the first edible substance from the molds, the surface or the pan when desired or required to form the outer layer 10. In these embodiments, the non-stick substance can help to preserve or to increase the malleability and/or the consistency of the first edible substance.

In other embodiments, a temperature of the non-stick wrapping material, the molds, the surface or the pan and/or the outer layer 10 formed therein can be fluctuated, e.g., by running warm or hot water over a surface of the non-stick wrapping material, the molds, the surface or the pan or by removing the non-stick wrapping material, the molds, the surface or the pan with the outer layer 10 contained therein to a warmer temperature.

In other embodiments of the invention, the outer layer 10 can be formed, by any of the processes described above at stage 110, in advance of use, e.g., before being shaped and/or filled into the resultant frozen confection, to provide the outer layer 10 as a “ready-made” and/or prepackaged outer layer 10, e.g., for use by consumers or vendors as the outer layer 10 of the resultant frozen confection 18. In a further embodiment, forming the outer layer 10 by any of the processes at stage 110 described above, can be performed at or close to a time of consumption, e.g., consumers or vendors can roll out or form a “custom order” shape or configuration of the outer layer 10 to make the frozen confection 18.

As shown in FIG. 2A, the outer layer 10 can have dimensions ranging from about 4 by 4 inches to about 20 by 20 inches, depending upon the desired or required shape or configuration of the resultant frozen confection 18. As shown in FIG. 2A, the outer layer 10 can have a length L₁ in one direction, e.g., along an x-axis, ranging from about 4 by 4 inches to about 20 by 20 inches, and a length L₂ in a second direction, e.g., along a y-axis, ranging from about 4 by 4 inches to about 20 by 20 inches. The outer layer 10 can have a thickness T₁ sufficiently thin, e.g., ranging from about 0.25 to about 0.5 inch, to help to permit the outer layer 10 to be shaped or configured into a different physical structure and/or to help to preserve a substantial malleability of the outer layer 10 required for a particular application. The outer layer 10 can have a substantially square or rectangular shape, as shown in FIG. 2A, and the frozen confection 18 formed therefrom can include a substantially cylindrical form, as shown in FIG. 2C.

The dimensions, shapes or configurations of the outer layer 10, however, do not limit the invention. Rather, the outer layer 10 can include different dimensions and can comprise any shape, e.g., a triangle, polygon, circle, star, half-moon, flower, or any combination of shapes, in accordance with the invention. In another embodiment, the outer layer 10 can include a shape having one or more openings, e.g., for adding one or more fillings to the resultant frozen confection 18. In another embodiment, at least a portion of the outer layer 10 can be formed to define a spout-like or a funnel-like configuration for inserting or adding one or more fillings to the frozen confection 18. In addition, the invention is not limited by the dimensions or shapes of the resultant frozen confection 18, but anticipates a variety of dimensions and shapes, as described below.

In at least one embodiment, the outer layer 10 is substantially malleable, e.g., having a texture, temperature, consistency and/or density to help to permit the outer layer 10 to be shaped or formed manually and/or automatically into a desired or required shape or configuration that defines a physical structure of the outer layer 10. In one embodiment, the physical structure of the outer layer 10 is different from a physical structure in which the first edible substance is provided for formation of the outer layer 10. In one embodiment, the thickness T₁ of the outer layer 10 can be sufficiently thin, e.g., from about 0.25 to about 0.50 inch, to help to permit the outer layer 10 to be substantially malleable. In one embodiment, the outer layer 10 has a texture similar to a texture of a flour or corn tortilla. In another embodiment, the outer layer 10 includes, at least in part, ice cream or other milk or dairy product having a butter fat content sufficient to help to achieve the desired thickness T₁ and/or a desired consistency or density to be substantially malleable.

In one embodiment, a temperature of the outer layer 10 includes a temperature that is sufficiently cold such that a person consuming the resultant frozen confection would perceive the outer layer 10 as “frozen”. In another embodiment, a temperature of the outer layer 10 includes a temperature ranging from about 10° F. to about 14° F.

Embodiments of the outer layer 10 according to the invention formed by any of the processes described above at stage 110, as well as by other well-known processes, can include the outer layer 10 with a structure that contains substantially no air or minimal air, e.g., an amount of air contained in the outer layer 10 such that formation of ice crystals due to the presence of air does not affect the substantial malleability of the outer layer 10. In one embodiment, the structure of the outer layer 10 contains less air than at least some conventional forms of frozen edible substances, e.g., ice cream. As noted, the outer layer 10 can include a sufficiently thin thickness T₁ such that substantially no or minimal air is contained in the outer layer 10 and thereby the formation of ice crystals is prevented or at least minimized/reduced. Minimizing/reducing the extent of the formation of ice crystals in the outer layer 10 helps to prevent and/or to at least minimize/reduce breaking and/or cracking of the outer layer 10 during its formation and in later stages when the outer layer 10 is formed into the frozen confection 18. In addition, minimizing/reducing the extent of the formation of ice crystals in the outer layer helps to preserve and/or to enhance the malleability of the outer layer 10.

In other embodiments, the dimensions of the outer layer 10 can be varied, depending on the ingredients of and/or the additives to the outer layer 10 and/or a temperature of the outer layer 10, to help prevent or to at least minimize/reduce the formation of ice crystals contained in the outer layer 10, and/or to preserve and/or to enhance the malleability of the outer layer 10.

Other embodiments of the outer layer 10 according to the invention formed by any of the processes described above at stage 110, as well as by other well-known processes, can include the outer layer 10 having a structure formed by any emulsification process well known in the art. The first edible substance can be processed into an emulsion to form the outer layer 10 such that the outer layer 10 has a desired or required degree of crystallization, range of particle size, volume or particle density, or structure, that produces the outer layer 10 with sufficient consistency, density and/or malleability for use in a certain application or method for making the resultant frozen confection. The emulsified structure of the outer layer 10 desired or required will depend on, for instance, a shape or configuration of the outer layer 10, a size or volume of the outer layer 10, and a method or device by which the outer layer 10 will be formed and further manipulated. During formation of the outer layer 10, one or more emulsifiers and/or crystallization agents, e.g., fat crystallization agents, can be added to or mixed with the first edible substance when the outer layer 10 is being formed.

At stage 115, the second edible substance 14 is provided having one or more of a variety of substances including, but not limited to, ice cream, e.g., homemade, gourmet shop or commercially-available ice cream, ice milk, frozen yogurt, frozen fruit, frozen dairy product, frozen non-dairy product, frozen non-dairy, milk-like product, any other frozen edible article, creme filling, cookies, candy, fruit, fruit roll-up type materials, pastry-like layers of edible material or any combination thereof. The second edible substance 12 can further include, but is not limited to, flavorings, e.g., natural or artificial, jellies, jams, vegetables, savory ingredients, e.g., herbs or spices, sundries, e.g., nuts, raisins, fried fruit, coconut, colors, e.g., provided by natural or artificial additives, and other additives, e.g., sugar, non-sugar sweeteners, milk, eggs, butter, butter fat, pastry, dough, flour, corn starch, salt, preservatives, other like ingredients or any combination thereof. The second edible substance 12 is provided at a temperature conducive for use with the outer layer 10 and/or for forming the frozen confection 18.

At stage 120, the second edible substance is disposed on at least a portion of the outer layer 10.

At stage 125, at least a portion of the outer layer 10 is shaped, molded and/or conformed to and/or around at least a portion of the second edible substance 12 such that the outer layer 10 at least in part defines a wrapper, a housing or an encasement to contain the second edible substance 12. As shown in FIG. 2B, the second edible substance 12 is disposed on at least a portion of the outer layer 10. The outer layer 10 can then be rolled, folded, shaped, conformed or otherwise configured to at least partially enclose and/or contain the second edible substance 12. In one embodiment, the outer layer 10 can be rolled or folded manually with an implement, e.g., a non-stick spatula, rolling pin or other tool, or can be rolled or folded automatically, e.g., by an automatic rolling or folding machine. The outer layer 10 can be rolled or folded to form a burrito, wonton or ravioli-type wrapper, or configured to from a cone, tube or other cylindrical-shaped housing, or shaped to form a cupped or tart-style encasement to enclose and/or contain at least a portion of the second edible substance 12. As shown in FIGS. 2B and 2C, in one embodiment, at least a first edge 10a of the outer layer 10 can be rolled or folded over the second edible substance 12. As shown in FIG. 2C, in another embodiment, the first edge 10a can be continuously rolled or folded under or over itself such that the outer layer 10 is gradually rolled or folded, e.g., manually with an implement or automatically with a device configured to aid in rolling or folding. The outer layer 10 can be rolled or folded in substantially one direction to at least partially enclose or contain the second edible substance 12 such that the outer layer 10 forms a substantially cylindrical roll, e.g., having a burrito-like shape. In other embodiments, the outer layer 10 can be rolled or folded from the first edge 10a and from a second edge 10b to at least partially enclose or contain the second edible substance 12. The outer layer 10 according to the invention, therefore, can include a variety of shapes formed as described above that contain or hold the second edible substance. The invention is not limited by a shape or configuration of the resultant frozen confection 18 and anticipates a variety of shapes and configurations.

In other embodiments, the outer layer 10 can be molded or shaped into a desired or required shape or configuration that substantially defines a housing, e.g., a heart, half-moon or lightening bolt, that defines an interior shape or is partially or substantially solid into which the second edible substance 12 can be added to at least partially fill the interior shape of the outer layer 10 post-molding by any methods known in the art for injection-molding confection fillings. For example, the second edible substance 12 can include substances having sufficient fluidity such as fruit filling or other flavored liquids. In these embodiments, the second edible substance 12 can either be at a cool temperature and sufficiently cold or frozen, or, alternatively, can be at a room temperature or a temperature relatively warmer than the outer layer 10. In these embodiments, the outer layer 10 can be chilled or frozen. In addition, the outer layer 10 can further include have a thickness sufficient to permit a straw to puncture the outer layer 10 such that the fluid second edible substance 12 can be drawn through the straw for sipping.

In further embodiments, the outer layer 10 can be provided at a first temperature, e.g., a sufficiently cool temperature such that the outer layer 10 is substantially cold or frozen, and the second edible substance can be provided at the first temperature such that the second edible substance 12 is substantially cold or frozen. For example, the outer layer 10 can include a substantially frozen layer of ice cream and the second edible substance 12 can include a substantially frozen mixture of ice cream including various add-ins, e.g., candy and nuts. In another embodiment, the outer layer 10 can be provided at the first temperature and the second edible substance 12 can be provided at a second temperature, e.g. a temperature relatively warmer than the first temperature, such that the outer layer 10 and the second edible substance 12 are at different temperatures. For example, the outer layer 10 can include a substantially frozen layer of ice cream and the second edible substance can include a warm fruit mixture.

In other embodiments of the invention, it is desirable or required that the resultant frozen confection 18 retain its “frozen” or chilled state such that the frozen confection 18 substantially retains its shape or configuration for a period of time. In particular, it is advantageous that the frozen confection 18 will retain its “frozen” or chilled state when being consumed such that the frozen confection 18 retains its shape, attractiveness, and desirability. To that end, in one embodiment, one or more additives can be included with the first edible substance during the formation of the outer layer 10 and/or during the formation or addition of the second edible substance 14 to produce the frozen confection 18 to help to retain the shape or configuration of the frozen confection 18 in unrefrigerated conditions. Such additives include, but are not limited to, crystallizers and stabilizers, e.g., polysaccharide stabilizers, and other well-known agents used to prolong the “frozen” state of frozen products. In other embodiments of the invention, it is desirable or required that the resultant frozen confection 18 be provided in a freeze-dried state, e.g., at or about temperatures ranging from about −196° C. to about −86° C., to help to retain the shape or configuration of the frozen confection 18, and, in particular, a premade and/or prepackaged frozen confection 18, e.g., that may be vended or distributed under unrefrigerated conditions.

At stage 130, at least in certain embodiments of the invention, the resultant frozen confection can be further processed or manipulated, e.g., by frying (a.k.a. “fried ice cream”), blanching, baking, dipping and/or rolling in one or more coatings, any other cooking or manipulating process, or any combination thereof. In one embodiment, the resultant frozen confection according to the invention is at the same temperature at which it was formed or can be served at a different temperature.

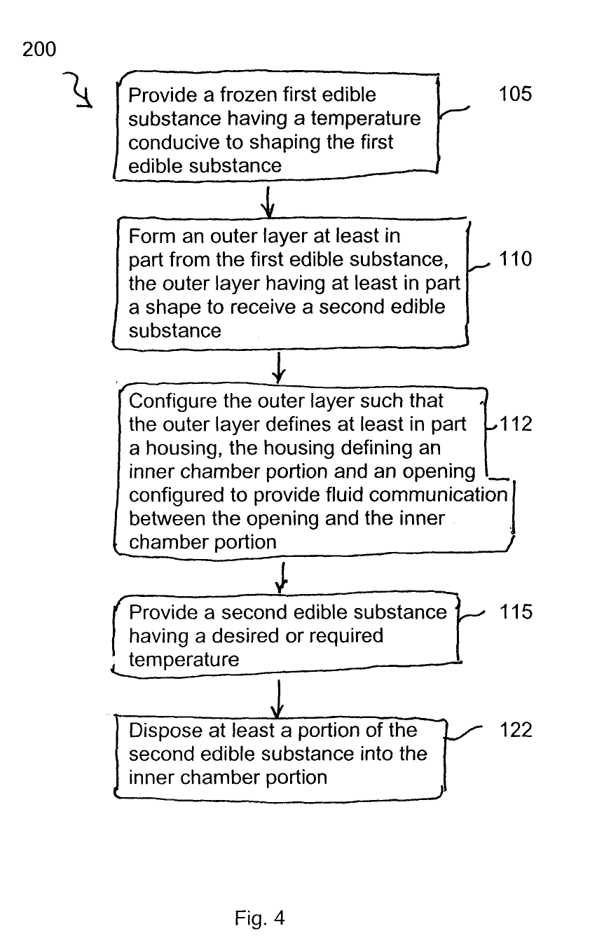

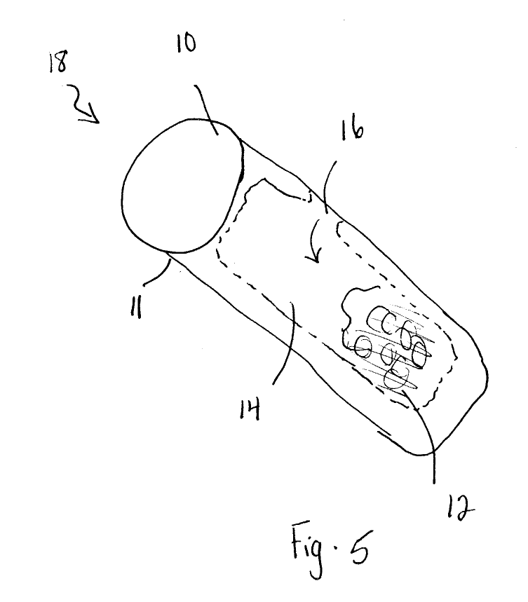

Referring to FIG. 4, and in further reference to FIG. 5, in another aspect, a method 200 for making a frozen confection is provided that is similar to the method described above with reference to stages 105, 110, 115 and 130, and further includes stages 112 and 122, as described below. The method 200 is exemplary only and not limiting. The method 200 can be altered, e.g., by having stages added, removed or rearranged.

At stage 112, the outer layer 10 comprises a shape or configuration that at least in part defines a housing 11. The housing 11 is configured such that it defines an inner portion 14 and defines an opening 16 to the inner portion 14. As shown in FIG. 5, the inner portion 14 is configured such that it is in fluid communication with the opening 16, and the opening 16 is configured to provide access to the inner portion 14 such that the second edible substance can be readily added or filled into the inner portion 14. The inner portion 14 and the opening 16 can be formed during the formation of the outer layer 10, for instance, as a last step of forming the outer layer 10. Alternatively, the inner portion 14 and the opening 16 of the outer layer 10 can be formed using a mold, as described above in stage 110 with reference to the embodiments using molds to form the outer layer 10.

At stage 122, the inner portion 14 is filled with one or more of the second edible substance 14 via the opening 16 such that the resultant frozen confection 18 is formed.

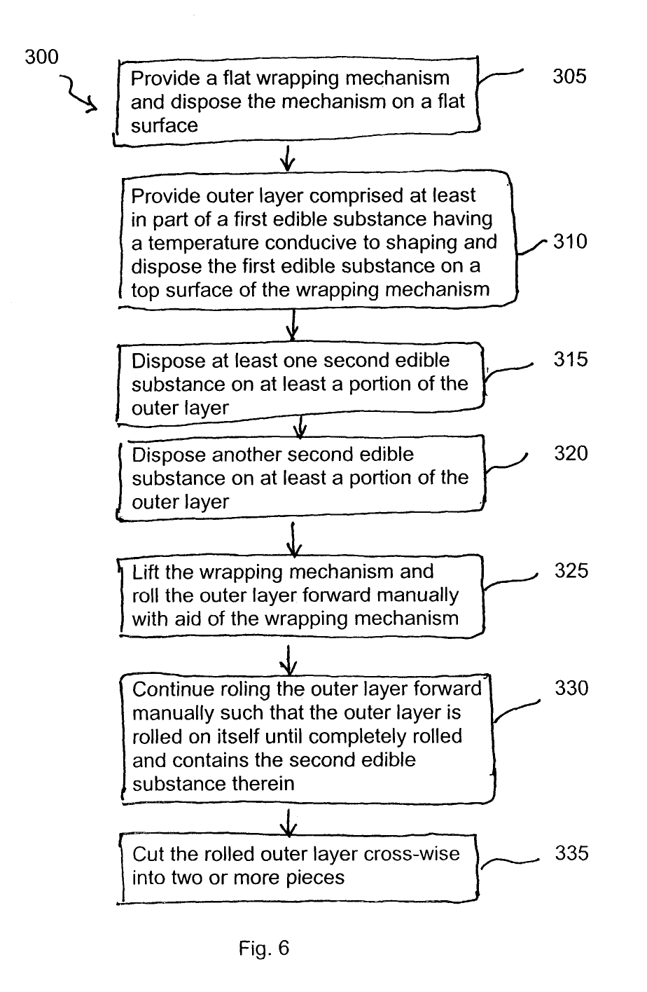

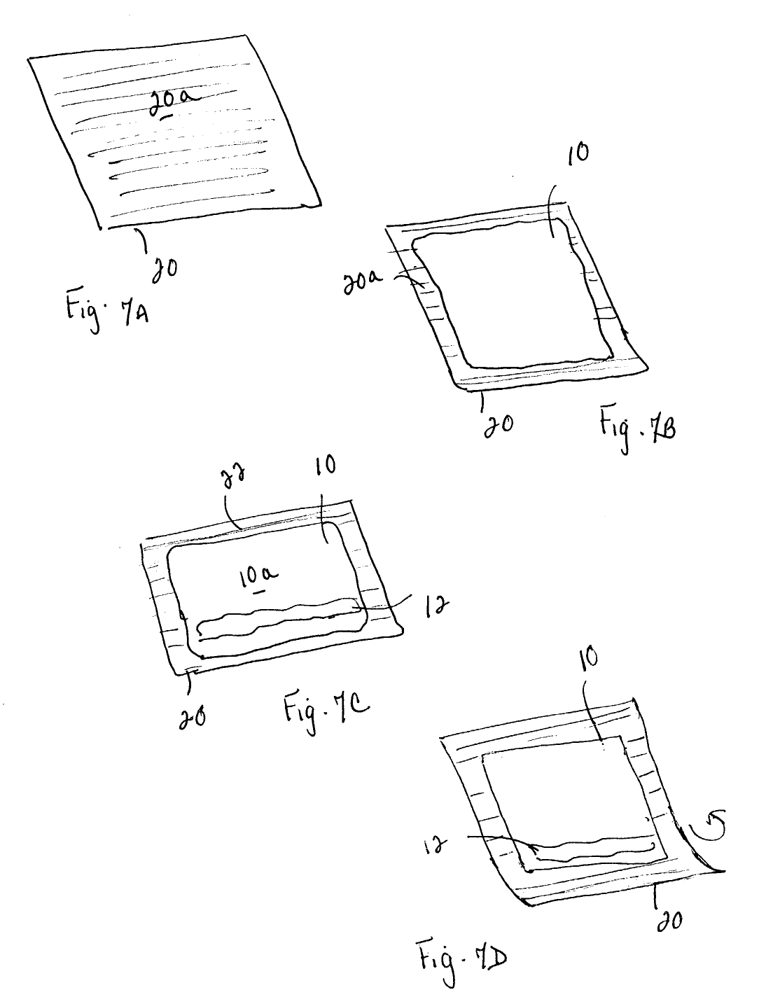

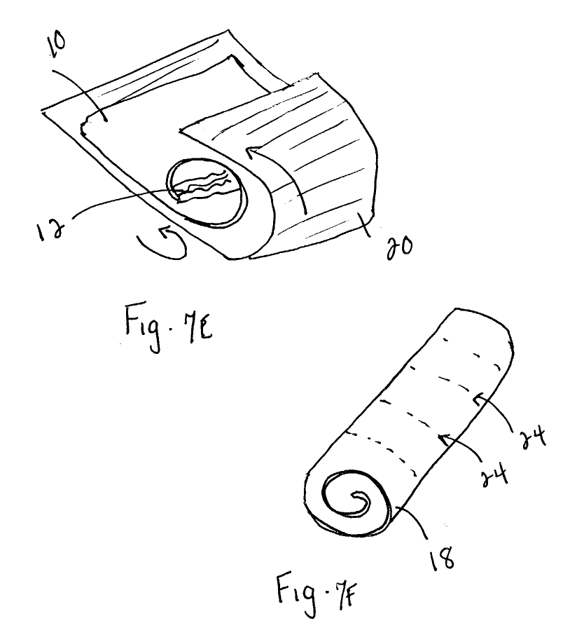

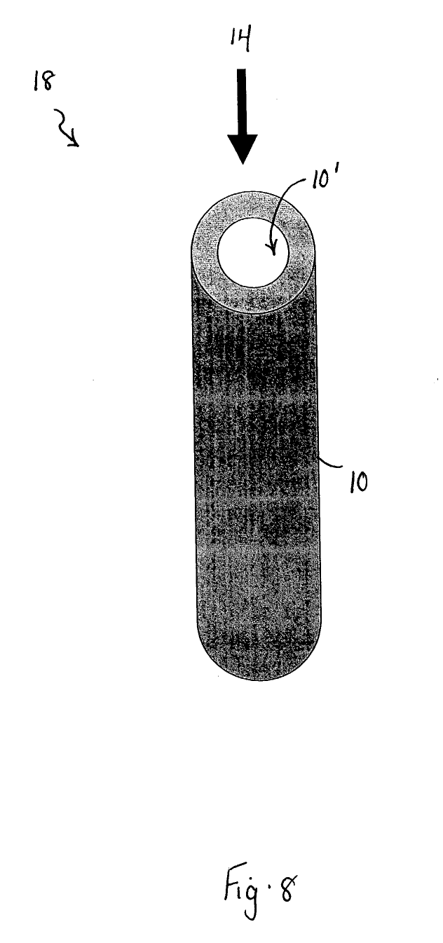

Referring to FIG. 6, and in further reference to FIGS. 7A-7F, in still another aspect, a method 300 for making a frozen confection using a substantially malleable outer layer 10 comprised of the first edible substance 10 to contain the inner second edible substance 12 is provided that is similar to a method for manually rolling a sushi-like roll. The method 300 is exemplary only and not limiting. The method 300 can be altered, e.g., by having stages added, removed or rearranged.

At stage 305, a substantially flat wrapping mechanism 20, e.g., a bamboo mat, is provided and disposed on a substantially flat surface, e.g., in the case of the bamboo mat, the mat is disposed such that the slats of the mat, if present, extend horizontally in front of a user, as shown in FIG. 7A.

At stage 310, an outer layer 10 having desired or required dimensions of the resultant frozen confection and, if desired, other ingredients, are provided at a temperature conducive to shaping and, as shown in FIG. 7B are disposed on a top surface 20a of the wrapping mechanism 20.

At stage 315, at least one second edible substances 12 is disposed in a substantially thin layer on a top surface 10a of the outer layer 10, and, as shown in FIG. 7C, leaving a margin 22 of about 1 to about 1.5 inch along a farthest perimeter edge of the outer layer 10 free of the second edible substance 14.

At stage 320, if desired or required, at least another second edible substance 12, and, if desired, other ingredients, are disposed in along a portion of the outer layer 10 adjacent to a closest perimeter edge of the outer layer 10.

At stage 325, the wrapping mechanism 20 is lifted manually, as shown in FIG. 7D and the outer layer 10 and the second edible substance 14, and other ingredients, are held manually substantially by tucking in manually each side edge of the outer layer 10 extending along each side edge of the wrapping mechanism 20 and folding manually from a bottom side of the wrapping mechanism 20.

At stage 330, as shown in FIG. 7E, the wrapping mechanism 20 is continually manually rolled forward and frequently pulled manually forward slightly such that the outer layer 10 is rolled over on itself without rolling the wrapping mechanism therein until the outer layer 10 is completely rolled.

At stage 335, the outer layer 10 can be cut cross-wise into slices 24, e.g., having a thickness of about 0.75 inches, or the outer layer can remain intact, e.g., form a burrito-type wrap, as shown in FIG. 7F.

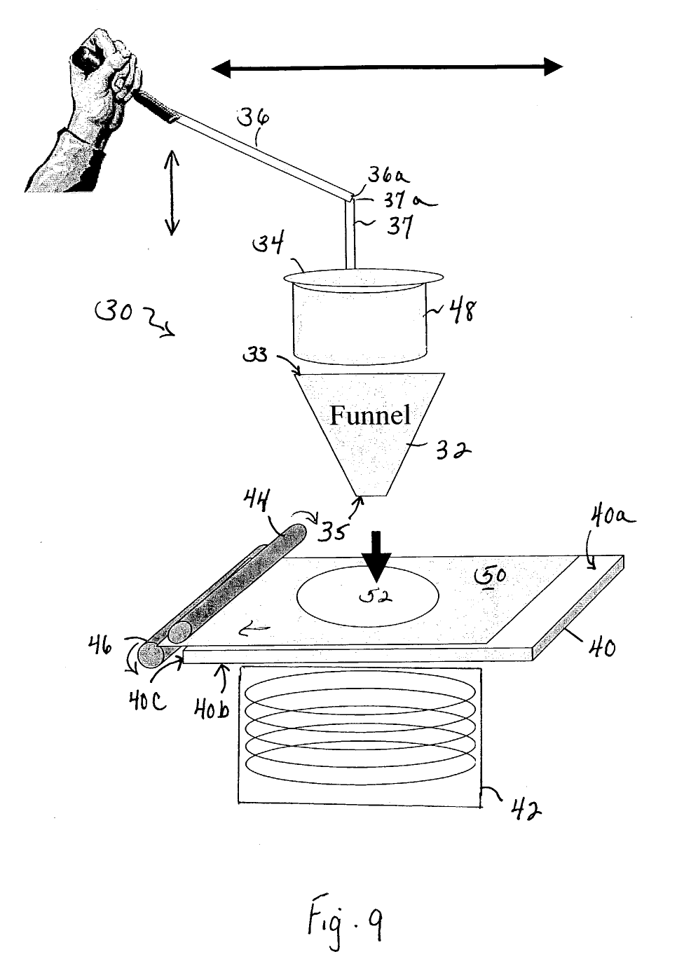

Referring to FIG. 8, in one embodiment of the invention, the outer layer 10 can be configured in a tubular or cylindrical shape that defines an elongated chamber 10′. The tubular or cylindrical outer layer 10 can include a circular cross-section. The chamber 10′ can be configured to receive one or more of the second edible substance 14. The tubular or cylindrical outer layer 10 can be formed by a mold or manual shaping, or by any similar methods, as described above. In particular, the tubular or cylindrical outer layer 10 can comprise a preformed and prepackaged outer layer 10 for use by vendors and consumers. A plurality of the tubular or cylindrical outer layers 10 can be prepackaged and distributed. The tubular or cylindrical outer layer 10 can serve as a receptacle for the second edible substance 14 and can equally serve as an edible container to hold the second edible substance 14 during consumption.

Referring to FIG. 9, in a further aspect of the invention, a dispensing apparatus 30 is provided to dispense the first edible substance and to form the outer layer 10 of the frozen confection 18 in a desired or required shape. The dispensing apparatus 30 includes a funnel 32 for dispensing an amount of the first edible substance, a pusher 34 configured and arranged such that the pusher 34 is received at an open top terminal end 33 of the funnel 32, a rod 37 attached to the pusher 34 to move and to insert the pusher 34 into the open top terminal end 33 of the funnel 32, a lever 36 pivotally connected at a terminal end 36a to a terminal end 37a of the rod such that the lever 36 can be moved vertically and moved horizontally, and a handle 39 disposed at an opposite end of the lever 36 to provide ease in use of the lever 39.

The funnel 32 is disposed over a top surface 40a of a support 40 and can be positioned, for instance, by means of a frame or stand (not shown). The support 40 is disposed below a bottom open terminal end 35 of the funnel 32 at a certain distance and is further configured such that the support 40 receives the first edible substance at it is dispensed from the bottom terminal end 35 of the funnel 32. A bottom surface 40b of the support 40 is disposed at a certain distance or, alternatively, is in contact with a cooling unit 42 comprising one or more cooling coils such that the cooling unit 42 sufficiently cools the support 40 and, in particular, the top surface 40a to a desired or required temperature.

At one end of the support 40, a first roller 44, e.g., a thin rod constructed of stainless steel having a configuration similar to a skewer, is disposed substantially above the top surface 40a of the support 40 and adjacent to an edge 40c of the support 40. A second roller 46, e.g., having a substantially greater width than the first roller 44 and constructed of stainless steel, is disposed proximate to and substantially below the first roller 44, adjacent to the edge 40c of the support 40. The first roller 44 and the second roller 46 help to load and to convey and guide a sheet of non-stick material 50, e.g., wax paper, along the top surface 40a of the support 40 when the dispensing apparatus 30 is in use. For example, a sheet of wax paper 50 is fed between the first roller 44 and the second roller 46. The second roller 46 can include a configuration or an attachment (not shown) located on its surface or, alternatively, as each end to which a terminal edge of the sheet of wax paper 50 can be inserted and/or attached. As the second roller 46 rotates in a counterclockwise direction, the sheet of wax paper 50 is conveyed across the top surface 40a of the support 40 and under the first roller 44. The first roller 44 can rotate in a clockwise direction, making substantially minimal contact with the sheet of wax paper 50 such that the first roller 44 helps to guide the sheet of wax paper 50 as it is conveyed across the top surface 40a. The second roller 46 rotates in a counterclockwise direction and thereby winds the sheet of wax paper 50 onto the second roller 46 and moves the sheet of wax paper 50 across the top surface 40a.

With reference to FIG. 9, the dispensing apparatus 30 can be used to produce a plurality of the outer layers 10 from the first edible substance with relative ease and efficiency. For example, the first edible substance 48 can include ice cream or other edible substance 48, as described above. The ice cream 48 can be preformed such that it is configured in a shape or configuration to permit it to be inserted into the top terminal end 33 of the funnel 32. The ice cream 48 can be preformed to include a predetermined amount or volume of ice cream that is optimal for use with the dispensing apparatus 30. The ice cream 48 can be loaded into the funnel 32 or disposed at or above the top terminal end 33. The pusher 34 abuts and contacts a top surface of the ice cream 48. The pusher 34 is preferably configured as a flat disc or shaped plane that includes a shape substantially similar to a shape of the top of the ice cream 48. As shown in FIG. 9, the ice cream 48 has a substantially circular cross-section and the pusher 34 is substantially configured as a circular disk having a surface area substantially similar to an area of the top surface of the ice cream 48. The lever 36 can be moved vertically in an upward direction and a downward direction to operate the pusher 34 and to permit the pusher 34 to exert a downward force on the top surface of the ice cream 48. When the lever 36 is pushed vertically upward, the lever 36 pivots at its terminal end 36a and causes the rod 37 to move downward. As the pusher 34 moves downward, it exerts a downward force on the top of the ice cream 48 and thereby forces the ice cream 48 through the funnel 32. As the pusher 34 continues to exert the downward force on the top of the ice cream 48, the ice cream 48 is forced through the bottom terminal end 35 of the funnel 32 and is dispensed therefrom by gravity onto the top surface 40a of the support 40. The lever 36 can be vertically moved downward to discontinue applying the pusher 34 to the top surface of the ice cream 48 when a desired or required quantity of the ice cream 48 has been dispensed to the support 40.

In one embodiment of the dispensing apparatus 30 according to the invention, the funnel 32 is not used to dispense the ice cream 48 onto the support 40. Rather, the ice cream 48 is dispensed on the top surface 40a of the support 40 by another device and/or method, e.g., manually scooping the ice cream 48 on the top surface 40a, and the lever 36 is used to activate the pusher 34 such that the pusher 34 contacts and exerts a downward force on the ice cream 48 to form the tortilla 52.

Although the dispensing apparatus 30 shown in FIG. 9 graphically illustrates and is described herein as a manually operated dispensing device such that the lever 36 is moved manually, e.g., by hand, both vertically and horizontally, the invention is not limited to the manually-operated dispensing apparatus 30. Rather, the invention anticipates that at least operation of the lever 36 of the dispensing device 30 is automated such that an electromechanical device, e.g., a robotic arm, can operate, e.g., by a programmable microprocessor or a PC-type of computer, at least the lever 36 to dispense the ice cream 48 onto the support 40. In addition, the first roller 44 and/or the second roller 46 can be similarly automated for automatic operation.

The bottom terminal end 35 of the funnel 35 can be configured such that as the ice cream 48 is dispensed from the funnel 32, the ice cream 48 is conformed to a particular shape or configuration. For example, the bottom terminal end 35 can include a circular cross-section such that as the ice cream 48 is dispensed, the ice cream 48 is forcibly configured into a shape of a perimeter edge defining the bottom terminal end 35, and, in this case, is configured into a substantially cylindrical shape with a substantially circular cross-section. When the cylindrical shape of the ice cream 48 contacts the top surface 40a of the support 40, the cylindrical shape helps to conform the dispensed ice cream into a substantially circular shape or configuration such that the dispensed ice cream includes a shape substantially similar to, for instance, a tortilla 52. The ice cream 48 is preferably dispensed onto the sheet of wax paper 50 previously loaded to the dispensing apparatus 30 as described above.

The top surface 40a of the support 40 is at a desired or required temperature to help to preserve or to lower the temperature of the ice cream tortilla 52 such that the shape of the ice cream tortilla 50 is maintained after it is dispensed. Once the ice cream tortilla 52 is formed, the lever 36 can be moved in a horizontal direction, either from left to right or from right to left to activate the bottom roller 46 and, if desired, to activate the top roller 44 such that the bottom roller 46 rotates in a counterclockwise direction to convey the sheet of wax paper across the top surface 40a of the support 40 toward the first roller 44. As the ice cream tortilla 52 is conveyed along with the sheet of wax paper 50, the sheet of wax paper 50 peels away from the ice cream tortilla 52 and is rolled onto the bottom roller 46. The ice cream tortilla is thereby dispensed from the dispensing apparatus 30.

The embodiments of the systems, methods and apparatus according to the invention as described herein, as well as other embodiments within the scope and spirit of the invention, can provide unique and new types of frozen confections. For example, frozen confections according to the invention can be configured to resemble a variety of objects including cones, burritos, wontons, wraps, rolls, dumplings, pirogues, blintzes, crepes, raviolis, tacos, enchiladas and other food shapes. Further examples of frozen confections according to the invention include frozen confections having unique shapes or shapes embodying non-edible items including letters, numbers, figures, toys, toy dolls, cartoon characters, animals characters, shells, flowers and the like. Other examples of frozen confections according to the invention include frozen confections embodying various themes including shapes or configurations for use in advertising, promotion or marketing programs, and holiday-theme desserts. The invention is not limited with respect to shapes, configurations and dimensions of the outer layer 10 and the resultant frozen confection 18 formed therefrom.

Other embodiments of frozen confections produced according to the systems, methods and apparatus of the invention include, for example, frozen confections, with or without one or more of the second edible substance 12, that are provided in various shapes or configurations, as described above, and prepackaged as single or multiple items for use by vendors or consumers as premade frozen confections.

In addition, the various shapes or configurations described above can be premade and prepackaged or prebagged as a plurality of prepared frozen confections, e.g., similar to prebagged loose candy, and can be provided in sizes relative to the type of packaging. The packaging materials used to wrap and/or prepackage the premade outer layers 10 and the premade frozen confections 18 can include, but are not limited to, such materials as flexible and/or clear plastic or paper packaging materials, e.g., cellophane or plastic wrap, that permit the outer layers 10 and the premade frozen confections 18 to be decoratively packaged and/or visually displayed. The packaging materials can also include, but are not limited to, configured and/or decorative plastic or paper boxes, trays and bags of varying size, shape and weight to package, store and/or display the premade outer layers 10 and the premade frozen confections 18. Also, such prepackaged frozen confections according to the invention can be provided with a plastic or wooden spoon or scoop for eating, or the prepackaging can be configured with an opening or a spout configuration for eating.

The packaging materials described above can include insulated materials to contain and to store the frozen confections as described herein, and to substantially preserve a chilled or frozen state of the frozen confections when the frozen confections are not housed in refrigerators or contained in refrigerated storage.

In addition to prepackaging and other similar vehicles for storing and distributing the frozen confections described above, the frozen confections can be dispensed directly from one or more thermal-insulated, chilled or refrigerated dispensing units, e.g., similar to candy dispensing units or machines, to attractively display and to provide easy consumer access and sale of the frozen confections. In this context, the frozen confections according to the invention can include shapes or configurations of a particular size and shape such that the dispensing units can readily contain and vend the frozen confections to consumers. In addition, the frozen confections can comprise various shapes or configurations that mimic the look, feel and color of candy.

Frozen confection products produced in accordance with the systems, methods, and apparatus as disclosed herein can be known by a variety of names, including, but not limited to:

Ice cream rolls

Ice rolls

Ice wraps

Ice burritos

Frozen rolls

Rollice

Coldrolls

Coldwraps

In describing the embodiments of the invention herein, specific terminology was used for the sake of clarity. The invention, however, is not limited to the specific terms so selected, and each specific term at least includes all technical and functional equivalents that operate in a similar manner to accomplish a similar purpose.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as described herein.

What is claimed is:

1. A method for making a frozen confection comprising:
providing a frozen first edible substance at a temperature conducive to shaping the first edible substance;
forming an outer layer at least in part from the first edible substance, the outer layer having a shape disposed to receive a second edible substance;
disposing the second edible substance at a desired temperature on at least a portion of the outer layer; and
configuring the outer layer around at least a portion of the second edible substance such that at least a portion of the outer layer contains the portion of the second edible substance.

2. A method for making a frozen confection comprising:
providing a frozen first edible substance at a temperature conducive to shaping the first edible substance;
forming an outer layer at least in part from the first edible substance, the outer layer being configured and arranged to define at least in part a housing, the housing being configured to define an inner chamber and further configured to define an opening, the opening being disposed and configured to provide fluid communication between the opening and the inner chamber; and
inserting the second edible substance into the opening such that the second edible substance is received by the inner chamber and is disposed therein.

3. A method for making a frozen confection comprising:
providing a substantially flat wrapping mechanism on a substantially flat surface;
providing a frozen first edible substance at a temperature conducive to shaping the first edible substance;
forming an outer layer at least in part from the first edible substance, the outer layer having a shape disposed to receive a second edible substance;
disposing the outer layer on a top surface of the wrapping mechanism;
disposing the second edible substance at a desired temperature on at least a portion of the outer layer; and
rolling the wrapping mechanism such that the wrapping mechanism causes the outer layer to roll forward over its top surface until the outer layer is completely rolled over itself and contains the edible substance therein.
